(19) United States
(12) Patent Application Publication
(10) Pub. No.: US 2016/0203637 A1
(43) Pub. Date: Jul. 14, 2016

(54) METHOD AND APPARATUS FOR CONSISTENT SEGMENTATION OF 3D MODELS

(71) Applicants: Tao LUO, Beijing (CN); Pei LUO, Beijing (CN); Kangying CAI, Beijing (CN)

(72) Inventors: Tao LUO, Beijing (CN); Pei LUO, Beijing (CN); Kangying CAI, Beijing (CN)

(21) Appl. No.: 14/392,308

(22) PCT Filed: Jun. 25, 2013
(86) PCT No.: PCT/CN2013/077843

§ 371 Date: Dec. 23, 2015

(51) Int. Cl. G06T 17/10

(52) U.S. Cl. CPC G06T 17/10

(57) ABSTRACT

A method and apparatus for consistent segmentation of a set of 3D models is provided. The method comprises: over-segmenting each 3D model in the set of 3D models into patches, each of which comprises at least one primitive of the 3D model; computing at least one feature descriptor on each 3D model which is used for the segmentation of the 3D model; defining a feature vector for each patch over the at least one feature descriptor computed on each 3D model; calculating a low-rank and sparse representation for each feature descriptor by using the feature vectors; and clustering the patches with a fused sparse and low-rank representation.

### TECHNICAL FIELD

The present invention generally relates to 3D (three dimensional) compression technology. In particular, the present invention relates to a method and apparatus for consistent segmentation (co-segmentation) of 3D models.

### BACKGROUND

In the processing of 3D models in computer graphics, the segmentation of a set of 3D models is a primary step and an important pre-precessing for the shape understanding of the 3D models. With the segmentation process, the set of 3D models could be partitioned into multiple segments, which can simplify and/or change the representation of 3D models into something that is more meaningful and easier to analyze. With the increasing number of 3D models, it has been an intensive research topic for the consistent segmentation of a dataset of 3D models to be associated with correspondence.

FIG. 1 is an exemplary diagram showing a consistent segmentation of a set of 3D Teddy models. As shown in FIG. 1, each 3D Teddy model could be segmented into four parts, which are head, legs, ears and body. The correspondence of parts can be built with the same labeling numbers among the dataset. In FIG. 1, the parts of the head, the leg, the ears and the body are respectively indicated by the labeling numbers P.1, P.2, P.3 and P.4. It can be appreciated by a person skilled in the art that the consistent segmentation will benefit the co-analysis of a dataset of 3D models, such as dataset compression, editing, modeling, shape retrieval, etc.

Some methods have been proposed for a consistent segmentation of a set of 3D models, which can be categorized into supervised, unsupervised and semi-supervised methods. It is known to a person skilled in the art that the above mentioned categorization depends on whether the input is composed of manual segmentations, none of manual ones, or part of manual ones.

In a paper of E. Kalogerakis, A. Hertzmann, K. Singh, entitled “Learning 3D Mesh Segmentation and Labeling”, ACM Trans. on Graphics, vol. 29, no. 4, pp. 102:1-102:12, 2010 (hereinafter referred to as reference 1), a supervised method was provided. In the reference 1, features are selected by JointBoost, which is a machine learning method employed for selecting appropriate features. The JointBoost requires a training dataset.

In a paper of R. Hu, L. Fan, L. Liu., entiled “Co-Segmentation of 3D Shapes via Subspace Clustering”, Computer Graphics Forum (SGP 2012), vol. 31, no. 5, pp. 1703-1713, 2012 (hereinafter referred to as reference 2), an unsupervised method was discussed. The reference 2 proposes to extend the multi-task learning in image processing to fuse multiple features in shape segmentation. However, an additional parameter is introduced, which increases the complexity of optimization. And a sparse subspace clustering method is presented, which exploits the sparsity of representation by the linear combination of points belonging to the same subspace. This method only captures the local linear relationship among data points, which is sensitive to noise and outlier.

In a paper of Y. Wang, S. Asafi, O. Kaick, H. Zhang, D. Cohen-Or, B. Chen, entitled “Active Co-Analysis of a Set of Shapes”, ACM Trans. on Graphics, vol. 31, no. 6, pp. 165:1-165:10, 2012 (hereinafter referred to as reference 3), a semi-supervised method was proposed. In the solution of the reference 3, an active learning method is employed, which requires the input of a user.

In a dataset of 3D models from one category, although the semantic parts which are inherent in multiple shapes are consistent, there exist large variations among these shapes in geometry and topology. Therefore, it is not enough to achieve satisfactory results using only one shape descriptor. In order to improve the quality of the consistent segmentation, more shape descriptors are beneficial, which however will inevitably increase the computing complexity. But since the quality will be improved much better by using multiple shape descriptors than only using one, conventional segmentation methods for a set of 3D models usually will take multiple shape descriptors into account.

### SUMMARY

In view of the above problem in the conventional technologies, the invention proposes an unsupervised method and apparatus for consistent segmentation of 3D models, wherein the consistent segmentation is formulated as a multi-view spectral clustering task by co-training a set of affinity matrices for different shape descriptors. This method does not require training data, user input, and additional parameters for multiple features.

According to one aspect of the invention, a method for consistent segmentation of a set of 3D models is provided. The method comprises: over-segmenting each 3D model in the set of 3D models into patches, each of which comprises at least one primitive of the 3D model; computing at least one feature descriptor on each 3D model which is used for the segmentation of the 3D model; defining a feature vector for each patch over the at least one feature descriptor computed on each 3D model; calculating a low-rank and sparse representation for each feature descriptor by using the feature vectors; and clustering the patches with a fused sparse and low-rank representation.

According to one aspect of the invention, an apparatus for consistent segmentation of a set of 3D models is provided. The apparatus comprises: means for over-segmenting each 3D model in the set of 3D models into patches, each of which comprises at least one primitive of the 3D model; means for computing at least one feature descriptor on each 3D model which is used for the segmentation of the 3D model; means for defining a feature vector for each patch over the at least one feature descriptor computed on each 3D model; means for calculating a low-rank and sparse representation by using the feature vectors; and means for clustering the patches with a fused sparse and low-rank representation.

It is to be understood that more aspects and advantages of the invention will be found in the following detailed description of the present invention.

### BRIEF DESCRIPTION OF THE DRAWINGS

The accompanying drawings are included to provide further understanding of the embodiments of the invention together with the description which serves to explain the principle of the embodiments. The invention is not limited to the embodiments.

In the drawings:

FIG. 1 is an exemplary diagram showing a consistent segmentation of a set of 3D Teddy models;

FIG. 2 is a flow chart showing a method for consistent segmentation of a set of 3D models according to an embodiment of the present invention;

FIG. 3 is an exemplary diagram showing an input dataset of hand models from Princeton Segmentation Benchmark;

FIG. 4 is an exemplary diagram showing the result of the over-segmentation of the dataset of hand models;

FIGS. 5-6 are exemplary diagrams respectively showing SDF and AGDvalues which are computed on each vertex of an individual hand model;

FIG. 7(a) is an exemplary diagram showing feature vectors on patches from over-segmentation;

FIG. 7(b) is a diagram showing the feature histogram on Patch 1 in FIG. 7(a);

FIG. 7(c) is a diagram showing the feature histogram on Patch 2 in FIG. 7(a);

FIG. 7(d) is a diagram showing the feature histogram on Patch 3 in FIG. 7(a);

FIG. 8 is a diagram showing an algorithm of multi-feature fusion;

FIG. 9 is an exemplary diagram showing the result of the consistent segmentation result of the dataset of hand models;

FIG. 10 is a diagram showing the comparison result of segmentation accuracy on Princeton Segmentation Benchmark; and

FIG. 11 is a block diagram showing the structure of an apparatus for consistent segmentation of a set of 3D models.

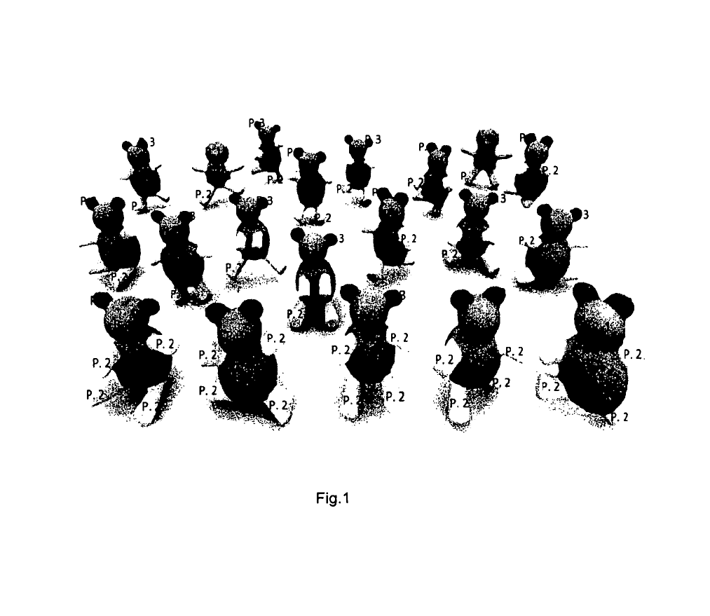

### DETAILED DESCRIPTION

An embodiment of the present invention will now be described in detail in conjunction with the drawings. In the following description, some detailed descriptions of known functions and configurations may be omitted for conciseness.

In a segmentation of a set of 3D models, since there are variations between different 3D models in the same category, it is hard to segment these 3D models individually and build the correspondence between the resulted components. Moreover, different feature descriptors capture different characteristics of the shapes and it is therefore almost impossible to find a kind of feature which is suitable for the segmentation of all shapes. In view of the foregoing problems, an embodiment of the invention proposes to employ a multi-view spectral clustering method to fuse multiple features in the segmentation. Furthermore, during the construction of the affinity matrix for each feature, the low-rankness is imposed to capture the global structures inherent in the shapes. The embodiment of the invention can segment a dataset of 3D models into meaningful parts in a consistent way and create the correspondence simultaneously.

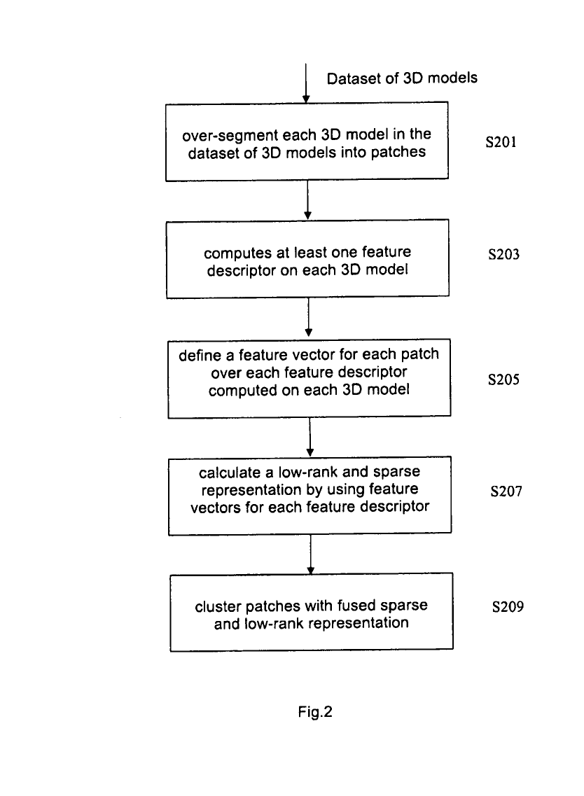

FIG. 2 is a flow chart showing a method for consistent segmentation of a set of 3D models according to an embodiment of the present invention.

In the embodiment shown in FIG. 2, the input of the method is a set of 3D models. For illustrative purpose only, as shown in FIG. 3, a dataset of hand models from Princeton Segmentation Benchmark is taken as an example of the dataset of 3D models for segmentation. Princeton Segmentation Benchmark is a public manual segmentation benchmark, which could be obtained for free from the following link http://segeval.cs.princeton.edu/.

As shown in FIG. 2, the method starts at step S201, wherein it over-segments each hand model in the dataset into patches. That is, the consistent segmentation of each 3D model can be implemented with patches. It is appreciated by a person skilled in the art that a patch could be composed of one or more model primitives. The common meaning of a model primitive refers to the simplest geometric objects that a computer graphics system can handle, such as triangles. In the image processing of computer graphics, a segmentation can be classified into under-segmentation and over-segmentation, which respectively refers to the case that a 3D model is partitioned into too few or too many segments. It should be noted that, in a very specific case each patch after the over-segmentation will contain only one model primitive. In this case, this step does not have many meanings in terms of the “over-segmentation”. But the embodiment of the invention still apply in this case.

A normalized cut method can be employed for the over-segmentation of each 3D model into patches in the step S201. In the normalized cut method, it computes firstly the dihedral angle of each pair of neighboring faces (a face indicates a model primitive, e.g. triangle). Then the Gaussian weights are calculated as their similarity metric. Finally, the normalized cuts method is performed on the similarity matrix to cluster faces into several patches.

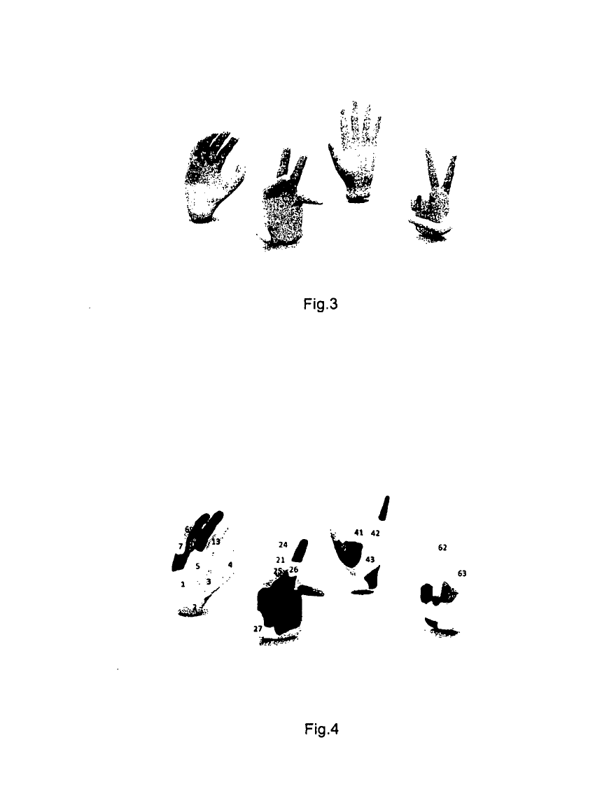

FIG. 4 is an exemplary diagram showing the result of the over-segmentation of the dataset of hand models at the step S201. As shown in FIG. 4, different labeling numbers indicate different patches on an individual 3D model. In this embodiment, each 3D model is over-segmented into 20 patches. The number of patches can be adjusted according to the complexity of 3D models. It could be appreciated that any other segmentation methods for a single 3D model can be used at the step S201 to obtain the over-segmentation results for each 3D model in the dataset.

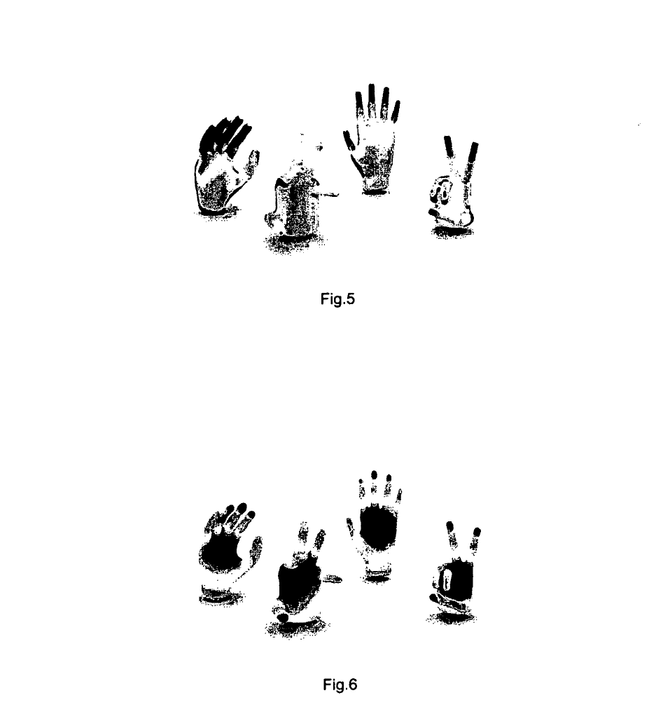

At step S203, it computes at least one feature descriptor on each 3D model. The feature descriptor, for example, could be Gaussian Curvature (GC), average geodesic distance (AGD) and shape diameter function (SDF), etc. Each feature descriptor can be used in the segmentation of a single 3D model. FIGS. 5-6 are exemplary diagrams respectively showing SDF and AGD values which are computed on each vertex of an individual hand model. SDF measures the diameter of the object's volume in the neighborhood of each point on the model. AGD is derived as the average of geodesic distance from a point on the model to all other ones, which represents the degree of protrusion of a part. The grey levels indicate different values in the FIGS. 5 and 6. In this experiment, only the above three features are considered. However, more kinds of features can be chosen according to the category of the 3D models. As seen in the figures, different kinds of features capture different characteristics of the models. Thus, it would be sufficient to represent different 3D models in a dataset by using multiple features.

At step S205 it defines a feature vector for each patch obtained from over-segmentation in the step S201 over each feature descriptor computed on each 3D model in the step S203. The above function can count the feature values (scalars or vectors) computed over each patch. As one example, for each feature descriptor, it could define a feature vector for each patch by computing a histogram which captures the distribution of this feature descriptor on the triangles of this patch. For each patch obtained in the step S201, the feature values have been computed on its vertices in the step S203.

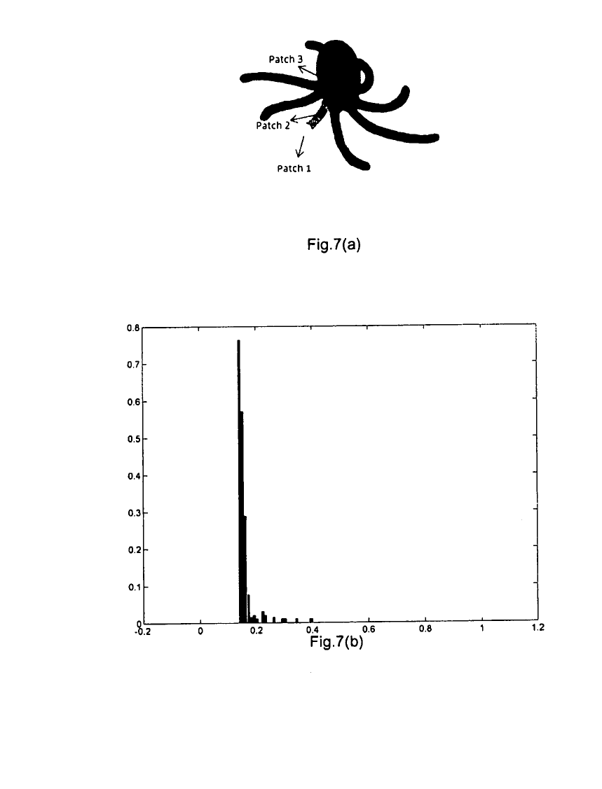

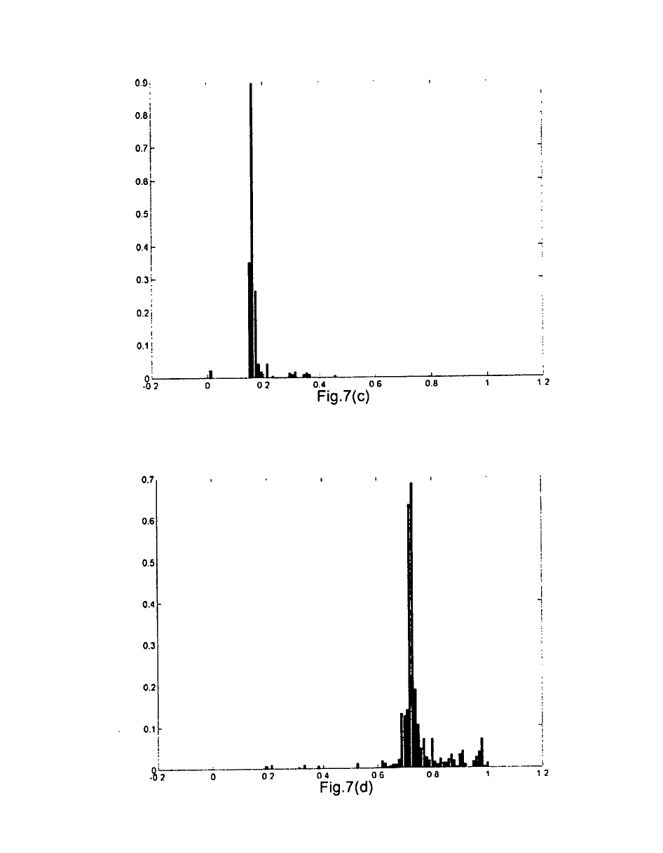

In this embodiment, the feature histogram is generated by setting the number of bins, which is the disjoint categories in which the number of feature values are counted, as 100, that is the dimension of a feature vector. Thus, a 3D model can be represented by a n*m matrix Pi, where n denotes the number of bins, m denotes the number of patches and each column of which denotes the feature vector for each patch. FIG. 7(a) is a diagram showing feature vectors on patches from over-segmentation by SDF. Using the SDF feature on a hand model, the two patches on tentacles, Patch 1 and Patch 2, and one patch on body, Patch 3, have quite different distributions. FIG. 7(b)-(d) show respectively the feature histogram on Patches 1, 2 and 3 in FIG. 7(a). As shown in the FIG. 7(b)-(d), the two feature diagrams on tentacles, Patch 1 and Patch 2, are similar, for which it tends to cluster into the same part. While the third one is on the body patch, Patch 3, is different from those of the Patches 1 and 2, which would be clustered into another part.

At step S207, it calculates a low-rank and sparse representation by using feature vectors for each feature descriptor. Let feature vectors on patches be input samples, denoted by Pi, each column of which represents the feature vector on one patch. Based on the theory of sparse representation, each sample of the input data can be represented as a linear combination of the other samples in the same cluster, which exploits the local linear relationship among the samples.

Furthermore, the low-rank representation is also based on the hypothesis of the linear relationship among samples, which finds the representation with lowest rank and captures the global structure. In a paper of L. Zhuang, H. Gao, Z. Lin, Y. Ma, X. Zhang, N. Yu. Entitled “Non-negative Low Rank and Sparse Graph for Semi-Supervised Learning”, CVPR, 2012, a method for low-rank and sparse representation is described (hereinafter referred to as reference 4). According to the reference 4, the affinity matrix Zᵢ for measurement of the similarity between a pair of patches can be derived from the following optimization problem.

$${min}_{{Z}_{i} , {E}_{i}} {‖ {Z}_{i} ‖}_{n} + α {‖ {Z}_{i} ‖}_{1} + λ {‖ {E}_{i} ‖}_{p} , \\ s . t . {P}_{i} = {P}_{i} {Z}_{i} + {E}_{i}$$

for the ith kind of feature, ∥Zᵢ∥₁ denote the nuclear norm of Zᵢ, which makes the solution to be lowest rank. And ∥Zᵢ∥₁ denote the l₁ norm of Zᵢ, which makes it to be sparse. Eᵢ denote the noise term. The parameter α is used to trade off the rankness and sparsity, and λ controls the size of noise. ρ is selected as the l_{2,1} norm in this embodiment.

The above problem can be solved by the popular Alternating Direction Method (ADM), which is proposed in a paper of S. P. Boyd and L. Vandenberghe, entitled“Convex Optimization”, Cambridge Univ. Press, 2004 (hereinafter referred to as reference 5). In this method, two auxiliary variables are introduced to separate the problem. The objective function can be rewritten using the augmented Lagrangian methods and the minimization problem can be solved by alternatively updating one variable while fixing the others. Thus, for each type of feature, the affinity matrix Zᵢ can be obtained.

It should be noted that, in this embodiment the module of augmented representations is introduced as an example of low-rank and sparse representation. The augmented representation can integrate more knowledge into the affinity matrix, such as the spatial proximity between a pair of patches. For example, if a pair of patches are derived from the same 3D model, their spatial proximity is based on whether there is a common boundary between them. The concavity along the boundary and the length are usually used to define the similarity. For a pair of patches from different 3D models, the two models should be aligned first, such as using principal component analysis (PCA). Then, for the faces on the first patch, if there exist the closest faces on the second patch, the similarity between these two patches can be defined using the properties of the pairs of closest faces, such as areas, distances, etc. Thus, an extra matrix can be generated to describe the spatial proximity between any pair of patches, which can be integrated into sparse and low-rank representation for an augmented representation. However, it could be appreciated that other types of representation is also applicable.

At step S209, it clusters patches with fused sparse and low-rank representation. After the affinity matrix for each type of feature has been computed in the previous steps, a co-training method could be employed to update the affinity matrix in order to make the clusters from different views consistent. A paper of A. Kumar, H. Daum III, entitled “A Co-Training Approach for Multi-View Spectral Clustering”, ICML, 2011 (hereinafter referred to as reference 6) proposed a multi-view spectral clustering method which is utilized to get the consistent segmentation by fusing multiple features.

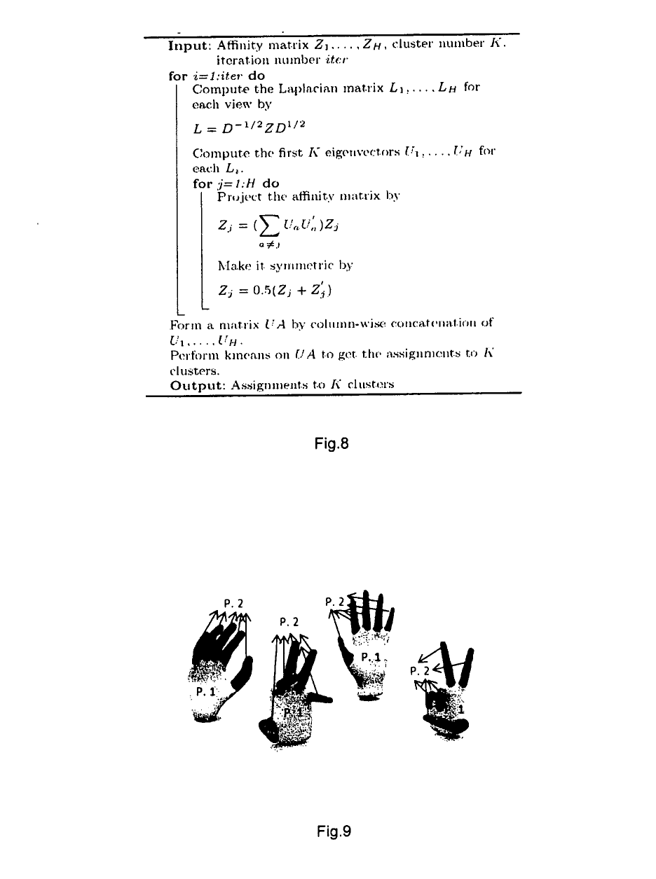

FIG. 8 is a diagram showing an algorithm of multi-feature fusion. The basic assumption behind this method is that the clusters derived from one feature agree with the clusters from the other features. The Laplacian matrix L can be computed using the affinity matrix Z for each kind of feature, where the diagonal matrix D is defined as

$${D}_{it} = {\sum }_{j} {Z}_{ij} .$$

In spectral clustering, the first Ki eigenvectors of the Laplacian matrix are the indicator vectors for the ith feature, which contain the discriminative information between clusters. The number Ki for different features can be the same or different. In this embodiment, the number Ki for each kind of feature is assigned to be the same as the number of parts K to be segmented. The indicator vectors for one feature can be used to improve the clusters from another feature. The process of multi-feature fusion is iterative. For each feature, a discriminative subspace can be spanned by the K eigenvectors. Then for the other features, their affinity matrices can be projected onto the subspace, which discards the intra-cluster details that confuse the clustering while preserves the discriminative inter-cluster information. In each iteration, the subspaces derived from all the features are traversed. Finally the K eigenvectors for each feature are concatenated column-wisely to form a matrix UA, which is used to perform k means clustering to obtain the final clusters of patches.

A post-processing can be operated for the result of step S209 to refine the segment boundary. It could be appreciated that the post processing is a optional step for which conventional methods can apply. No further details will be provided in this respect.

As described above, with the method for consistent segmentation of a set of 3D models according to an embodiment of the present invention, the consistent segmentation task is generally formulated as a multi-view spectral clustering task. First, each 3D model in the dataset of 3D models is over-segmented into a plurality of patches, which are used in the clustering algorithm to reduce the computational cost. Then, features on each 3D model are detected. For each feature, a low-rank and sparse graph representation is employed to achieve the affinity matrix that measures the similarity between patches. And the affinity matrix can be augmented optionally with more knowledge, such as the spatial proximity among the patches of 3D models. Each feature representation can be regarded as one view of the data. Finally, all the views are co-trained with each other and the consistent segmentation result is obtained by multi-view spectral clustering method. For each feature, the number of indicated eigenvectors can be determined adaptively during the co-training process.

FIG. 9 is an exemplary diagram showing the result of the consistent segmentation of the dataset of hand model. In this figure, each 3D model is segmented into two parts, P.1 and P.2, with different labels and the correspondence of the parts is obtained simultaneously among different 3D models.

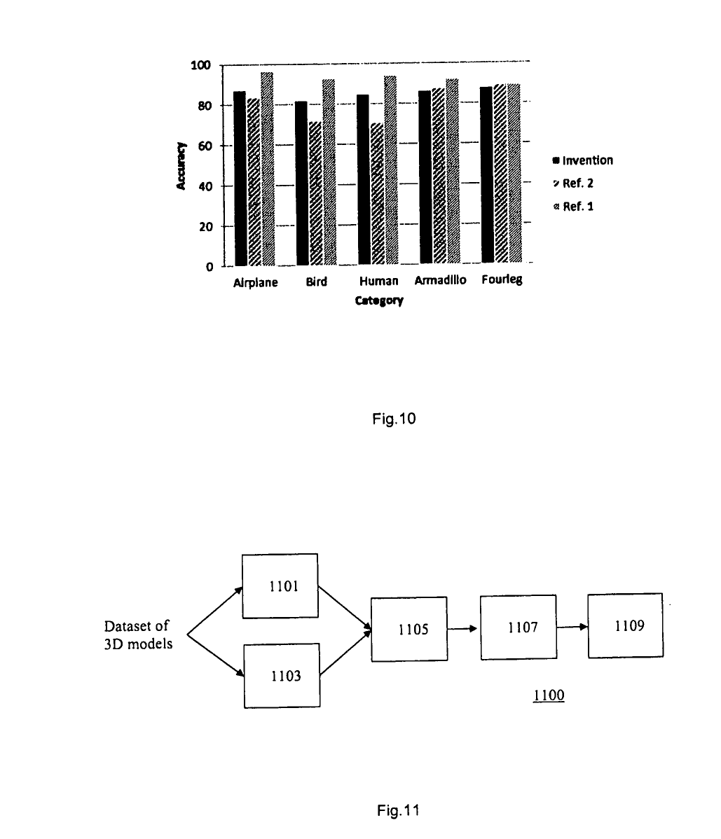

The result of the embodiment of the invention was compared with the unsupervised method in the reference 2 and the supervised method in the reference 1 on five categories (Human, Airplane, Bird, Armadillo, Fourleg) from Princeton Segmentation Benchmark. FIG. 10 is a diagram showing the comparison result of segmentation accuracy on Princeton Segmentation Benchmark. It could be appreciated that the supervised method in the reference 1 will have the best performance. As shown in FIG. 10, the accuracy of the embodiment of the invention is higher for Airplane, Bird and Human dataset than that of the unsupervised method in the reference 2 and very close for Armadillo and Fourleg dataset to that of the reference 2.

Another embodiment of the present invention provides a corresponding apparatus for consistent segmentation of a set of 3D models.

FIG. 11 is a block diagram showing the structure of an apparatus for consistent segmentation of a set of 3D models.

As shown in FIG. 11, the input of the apparatus 1100 is a set of 3D models. The apparatus 1100 comprises an over-segmentation unit 1101 for receiving the set of 3D models and over-segmenting each 3D model in the set of 3D models into patches. As described above, each patch comprises at least one primitive of the 3D model. A primitive of the 3D model refers to the simplest geometric objects that a computer graphics system can handle, such as a triangles.

The apparatus 1100 further comprises a feature detection unit 1103 for receiving the set of 3D models and computing at least one feature descriptor on each 3D model of the set of 3D models. Each computed feature descriptor should be able to be used in the segmentation of a single 3D model. Examples of the feature descriptor could be Gaussian Curvature (GC), average geodesic distance (AGD) and shape diameter function (SDF), etc.

The apparatus 1100 further comprises a feature analysis unit 1105 for receiving the results from the over-segmentation unit 1101 and the feature detection unit 1103 and defining a feature vector for each patch obtained from the over-segmentation unit 1101 over the feature descriptors computed on each 3D model by the feature detection unit 1103.

The apparatus 1100 further comprises a low rank and sparse representation unit 1107 for receiving the result from the a feature analysis unit 1105 and calculating a low-rank and sparse representation by using each feature vector obtained by the feature analysis unit 1105. The low rank and sparse representation can be in the form of an affinity matrix of the similarity between a pair of patches of each feature descriptor. In addition, the affinity matrix can be augmented to integrate more knowledge into the affinity matrix.

The apparatus 1100 further comprises a clustering unit 1109 for receiving the result from the low rank and sparse representation unit 1107 and clustering the patches with fused sparse and low-rank representation obtained by the low rank and sparse representation unit 1107.

The apparatus 1100 can further comprise a post-processing (not shown) for receiving the result from the clustering unit 1109 and refining the segment boundary.

It is to be understood that the present invention may be implemented in various forms of hardware, software, firmware, special purpose processors, or a combination thereof, for example, within any one or more of the plurality of 3D display devices or their respective driving devices in the system and/or with a separate server or workstation. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1-13. (canceled)

14. A method for consistent segmentation of a set of 3D models, comprising
over-segmenting each 3D model in the set of 3D models into patches, each of which comprises at least one primitive of the 3D model;
computing at least one feature descriptor on each 3D model which is used for the segmentation of the 3D model;
defining a feature vector for each patch over the at least one feature descriptor computed on each 3D model;
calculating a low-rank and sparse representation for each feature descriptor by using the feature vectors; and
clustering the patches with a fused sparse and low-rank representation.

15. The method according to claim 14, wherein the over-segmenting comprises:
computing the dihedral angle of each pair of neighboring primitives of the 3D model;
calculating Gaussian weights as the similarity metric of the primitives of the 3D model; and
clustering the primitives of the 3D model into patches with a normalized cuts method performing on a matrix of the similarity metric.

16. The method according to claim 14, wherein the at least one feature descriptor comprises Gaussian Curvature (GC), average geodesic distance (AGD) and shape diameter function (SDF).

17. The method according to claim 14, wherein the feature vector is defined by capturing the distribution of a feature descriptor on the primitive of the patch.

18. The method according to claim 14, wherein low rank and sparse representation is in the form of an affinity matrix of the similarity between a pair of patches of each feature descriptor.

19. The method according to claim 18, the affinity matrix is augmented using spatial proximity.

20. The method according to claim 14, further comprising a post-processing for the clustered patches to refine the segment boundary.

21. An apparatus for consistent segmentation of a set of 3D models, comprising a processor configured to:
over-segment each 3D model in the set of 3D models into patches, each of which comprises at least one primitive of the 3D model;
compute at least one feature descriptor on each 3D model which is used for the segmentation of the 3D model;
define a feature vector for each patch over the at least one feature descriptor computed on each 3D model;
calculate a low-rank and sparse representation by using the feature vectors; and
cluster the patches with a fused sparse and low-rank representation.

22. The apparatus according to claim 21, wherein the processor is configured to over-segment each 3D model in the set of 3D models by:
computing the dihedral angle of each pair of neighboring primitives of the 3D model;
calculating Gaussian weights as the similarity metric of the primitives of the 3D model; and
clustering the primitives of the 3D model into patches with a normalized cuts method performing on a matrix of the similarity metric.

23. The apparatus according to claim 21, wherein the at least one feature descriptor comprises Gaussian Curvature (GC), average geodesic distance (AGD) and shape diameter function (SDF).

24. The apparatus according to claim 21, wherein low rank and sparse representation is in the form of an affinity matrix of the similarity between a pair of patches of each feature descriptor.

25. The apparatus according to claim 24, wherein the affinity matrix is augmented using spatial proximity.

26. The apparatus according to claim 21, wherein the processor is further configured to post-process the clustered patches to refine the segment boundary.
